(19) United States
(12) Patent Application Publication
(10) Pub. No.: US 2010/0175994 A1
(43) Pub. Date: Jul. 15, 2010

(54) DISC-SHAPED MICROFLUIDIC DEVICE CAPABLE OF DETECTING ELECTROLYTES INCLUDED IN SPECIMEN BY USING ELECTROCHEMICAL METHOD

(75) Inventors: Jung-nam LEE, Incheon (KR); Beom-seok LEE, Hwaseong-si (KR); Jae-chan PARK, Yongin-si (KR); Jeong-gun LEE, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/555,188

(22) Filed: Sep. 8, 2009

(30) Foreign Application Priority Data
Jan. 12, 2009 (KR) 10-2009-0002383

(51) Int. Cl. G01N 27/333

(52) U.S. Cl. 204/416

(57) ABSTRACT

Provided is a rotatable disc-shaped microfluidic device which can electrochemically detect electrolytes comprised in a specimen. The microfluidic device including: a specimen chamber which accommodates a specimen; a detection chamber which receives the specimen from the specimen chamber; and an ion sensor which is formed in the detection chamber to electrochemically detect electrolytes in the specimen and includes an indicator electrode, a standard electrode and an ion selective film formed on a portion of the indicator electrode. The standard specimen is accommodated in the detection chamber, and a standard potential is measured. Then, the specimen is accommodated in the detection chamber, and a measurement potential is obtained to detect the concentration of the electrolytes comprised in the specimen.

### CROSS-REFERENCE TO RELATED APPLICATIONS

This application claims the benefit of Korean Patent Application No. 10-2009-0002383, filed on Jan. 12, 2009, in the Korean Intellectual Property Office, the disclosures of which are incorporated herein in their entirety by reference.

### BACKGROUND

1. Field

One or more embodiments relate to a disc-shaped microfluidic device which can electrochemically detect electrolytes included in a specimen.

2. Description of the Related Art

Recently, various methods for analyzing a specimen in various application fields, for example, environmental monitoring, food examination, medical examination, etc. have been developed, but these related art examination methods require many manual operations and various equipment. In order to perform an examination according to a predetermined protocol, a skilled examiner must manually perform many processes, for example, injection of a reagent, mixture, separation, movement, reaction, centrifugation, etc., several times, and these examination methods produce errors in the examination result.

In a diagnosis of an emergency patient, an examination result should be obtained quickly to ensure rapid treatment of the patient. In order to rapidly perform an examination, a skilled clinical pathologists is required. However, regardless of the skill of the clinical pathologists, it is difficult to perform various kinds of examinations at the same time. Thus, there is a need to develop an apparatus that can rapidly, accurately and simultaneously perform various pathological examinations according to the situation that arises.

For example, blood is injected into a disc-shaped microfluidic device and then the microfluidic device is rotated to perform separation of serum. The separated serum is mixed with a predetermined amount of a dilution buffer, and then the mixed solution is moved to a plurality of reaction chambers formed in the disc-shaped microfluidic device. Different reagents are injected in advance into the plurality of reaction chambers for each blood examination, so that each reagent reacts with the serum to produce a certain color. Blood analysis can be performed by detecting variations in the color. However, when electrolytes included in a biomaterial are analyzed using a reagent, if separation of a supernatant is imperfect, an analysis error may occur.

### SUMMARY

One or more embodiments include a disc-shaped microfluidic device which can detect electrolytes included in a specimen by performing electrochemical analysis.

To achieve the above and/or other aspects, one or more embodiments may include a microfluidic device which is rotatable and has a disc-shape, the microfluidic device including: a specimen chamber accommodating a specimen; a detection chamber receiving the specimen from the specimen chamber; and an ion sensor which is formed in the detection chamber to electrochemically detect electrolytes in the specimen and includes a standard electrode and an indicator electrode in which an ion selective film is formed on an end portion thereof.

The microfluidic device may include a centrifugation unit centrifuging the specimen accommodated in the specimen chamber into a supernatant and a sediment; a first channel connecting the centrifugation unit with the detection chamber; and a first valve selectively converting the first channel from an open state to a closed state.

The detection chamber may accommodate a standard specimen; and the microfluidic device may include a waste chamber accommodating the standard specimen discharged from the detection chamber, a second channel connecting the detection chamber with the waste chamber, and a second valve regulating flow of a fluid through the second channel. The second valve may include an open valve converting the second channel from a closed state to an open state, and a closing valve converting the second channel from an open state to a close state.

The microfluidic device may include: a standard chamber accommodating a standard specimen; a third channel connecting the standard chamber with the detection chamber; and a third valve converting the third channel from a closed state to an open state. The microfluidic device may include: a waste chamber accommodating the standard specimen discharged from the detection chamber; a second channel connecting the detection chamber with the waste chamber; and a second valve regulating flow of a fluid through the second channel. The second valve may include: an open valve converting the second channel from a closed state to an open state, and a closing valve converting the third channel from an open state to a closed state.

The microfluidic device may further include a biochemical analysis unit analyzing components of the specimen by using a reaction between the specimen and a reagent. The biochemical analysis unit may include a dilution chamber diluting the specimen according to a predetermined dilution ratio, and a reagent chamber accommodating a reagent and receiving the diluted specimen from the dilution chamber. The biochemical analysis unit may include a centrifugation unit centrifuging the specimen into a supernatant and a sediment, the dilution chamber dilutes the centrifuged supernatant, and the diluted supernatant is supplied to the reagent chamber.

To achieve the above and/or other aspects, one or more embodiments may include a microfluidic device which is rotatable and has a disc-shape, the microfluidic device including: a biochemical analysis unit analyzing components of a specimen using a reaction between the specimen and a reagent; and an electrochemical analysis unit electrochemically detecting electrolytes in the specimen by using an ion selective film.

The electrochemical analysis unit may include: a specimen chamber accommodating the specimen; a detection chamber accommodating a standard specimen; a first channel connecting the specimen chamber and the detection chamber; a first valve selectively converting the first channel from a closed state to an open state; an ion sensor which is formed in the detection chamber to electrochemically detect the electrolytes in the specimen and includes an indicator electrode having a standard electrode and an indicator electrode in which an ion selective film is formed on an end portion thereof, a waste chamber accommodating the standard specimen discharged from the detection chamber; a second channel connecting the detection chamber with the waste chamber; and a second valve regulating flow of a fluid through the second channel.

The electrical analysis unit may further include a centrifugation unit centrifuging the specimen accommodated in the specimen chamber, and the first channel may connect the centrifugation unit with the detection chamber.

### BRIEF DESCRIPTION OF THE DRAWINGS

These and/or other aspects will become apparent and more readily appreciated from the following description of the embodiments, taken in conjunction with the accompanying drawings of which:

FIG. 1 is an exploded perspective view of a microfluidic device according to an embodiment;

FIG. 2 is a plane view of an electrochemical analysis unit illustrated in FIG. 1;

FIG. 3 is a cross-sectional view along a line A-A′ of FIG. 2, according to an embodiment;

FIG. 4 is a perspective view illustrating an electrochemical analysis process of a specimen, according to an embodiment;

FIG. 5 is a plane view of an electrochemical analysis unit according to another embodiment; and

FIG. 6 is a plane view of a microfluidic device according to another embodiment.

### DETAILED DESCRIPTION

Embodiments will now be described more fully with reference to the accompanying drawings.

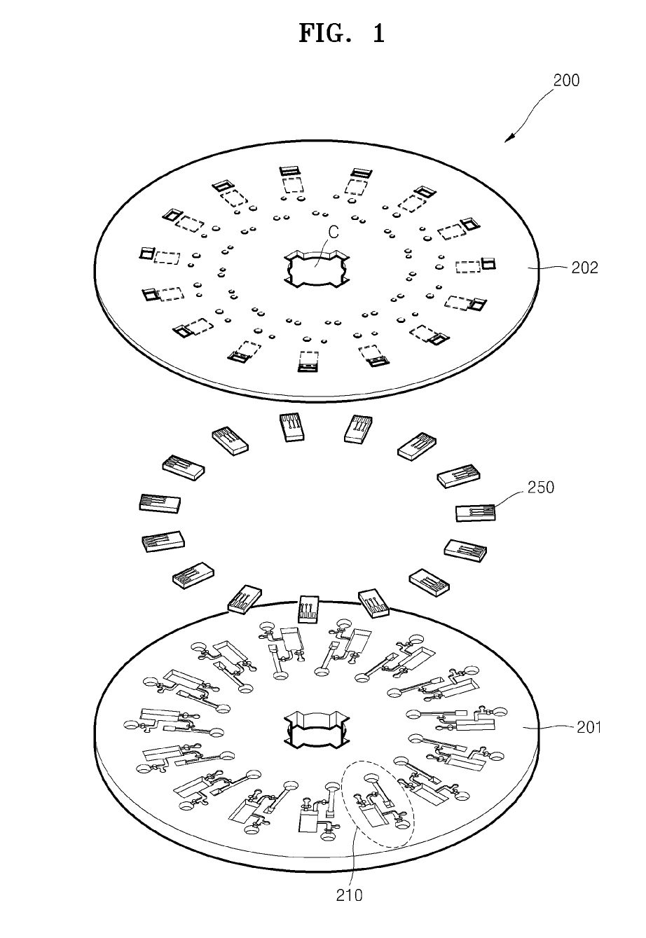

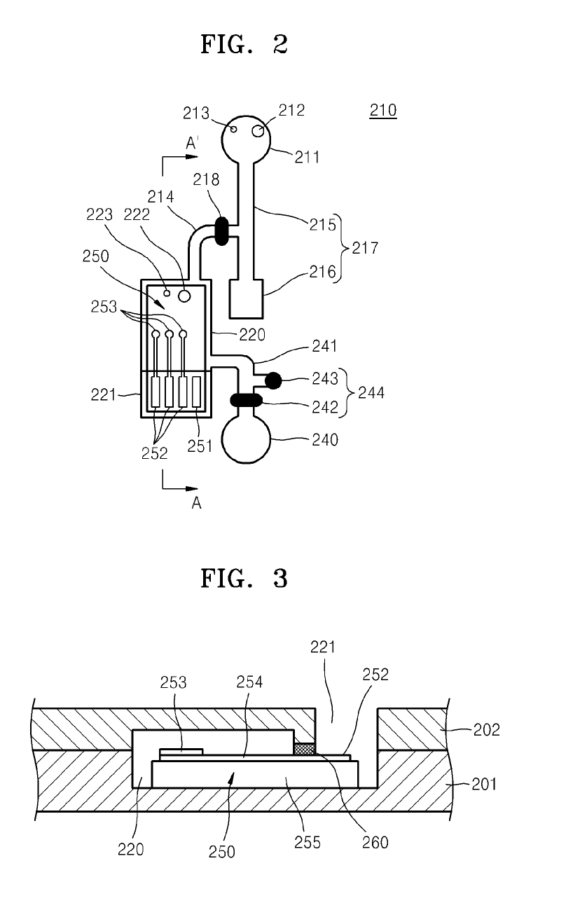

FIG. 1 is an exploded perspective view of a microfluidic device 200 according to an embodiment. FIG. 2 is a plane view of an electrochemical analysis unit 210 illustrated in FIG. 1.

Referring to FIG. 1, the microfluidic device 200 having a disc shape is installed in a rotation driving unit (now shown) of an analysis device (now shown) to rotate during analysis of a specimen. For this, an installation unit C is formed in a center portion of the microfluidic device 200. The microfluidic device 200 may include a plurality of electrochemical analysis units 210 for analyzing an amount of electrolytes included in the specimen by using an ion selective film. The degree to which the electrolytes permeate the ion selective film may be represented as a potential difference compared with a standard specimen. That is, the amount of electrolytes included in the specimen may be analyzed using a difference between or ratio of a potential with respect to the standard specimen and a potential when the electrolytes permeates the ion selective film.

Referring to FIG. 2, the electrochemical analysis unit 210 includes a specimen chamber 211 accommodating a specimen and a detection chamber 220 including an ion sensor 250. The specimen chamber 211 includes an inlet 212 into which the specimen is loaded. An air vent 213 facilitates flow of the specimen. The specimen chamber 211 is connected to the detection chamber 220 via a first channel 214. For example, in order to analyze electrolytes of blood, a centrifuged serum may be loaded into the specimen chamber 211. Also, when blood is loaded as the specimen, it is required to centrifuge the blood. For this, the electrochemical analysis unit 210 may further include a centrifugation unit 217. The microfluidic device 200 according to the current embodiment may be rotated by the analysis device, and thus the specimen may be separated into a supernatant and a sediment by using the centrifugal force. As illustrated in FIG. 2, the centrifugation unit 217 may include a supernatant collection unit 215, extending in a radial direction of the microfluidic device 200, and a sediment collection unit 216 formed in the end portion of the supernatant collection unit 215. The first channel 214 is connected to the supernatant collection unit 215. A first valve 218 may be formed in the first channel 214. The first valve 218 is an open valve for closing the first channel 214 and for opening the first channel 214 when necessary. Although not shown in the drawing, when the centrifugation unit 217 is not included in the electrochemical analysis unit 210, the first channel 214 directly connects the specimen chamber 211 with the detection chamber 220.

As illustrated in FIGS. 1 to 3, the ion sensor 250 may be fabricated in a chip shape and installed in the detection chamber 220. The ion sensor 250 includes a standard electrode 251 and an indicator electrode 252 which are formed on an insulating substrate 255. The standard electrode 251 is an ion anti-inductive electrode, and a potential of the standard electrode 251 is not changed by ions included in a specimen. The indicator electrode 252 is an ion selective electrode, and an ion selective film 253 reacting to a certain ion is formed on the end portion of the indicator electrode 252.

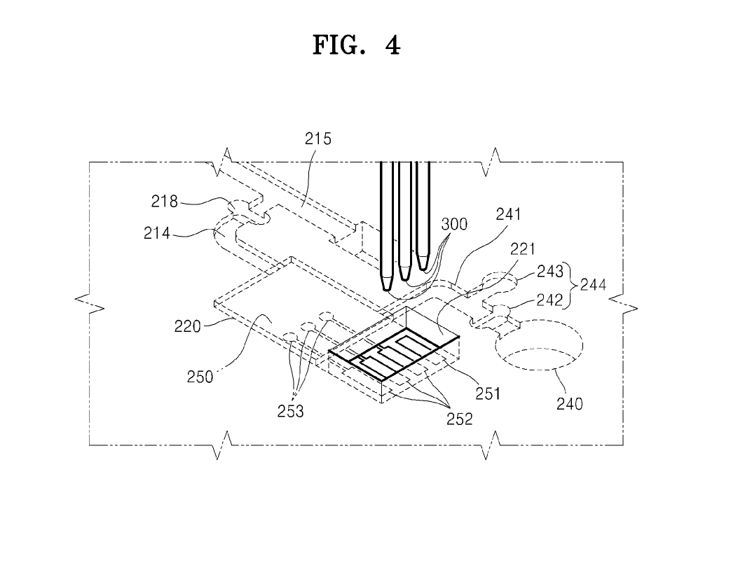

Referring to FIGS. 2 and 3, the ion selective film 253 may be formed on the end portion of an extension portion 254 extending from the indicator electrode 252. The ion selective film 253 includes an ionophore providing selectivity to a certain ion, a plasticizer providing flexibility to a membrane when sensing ions of the ionophore, and a matrix supporting the ionophore and the plasticizer. The ion selective film 253 may be fabricated by melting the ionophore, the plasticizer, and the matrix with a solvent and then shaping them. For example, in order to detect potassium (K+), an ion selective film including valinomycin as an ionophore, di-(2-ehtylhexyl) adipate (DEHA) as a plasticizer, and polyvinyl chloride (PVC) as a matrix may be used. In order to detect sodium (Na+), an ion selective film including monecsin methylester as an ionophore, O-nirtophenyl octylether as a plasticizer, and PVC as a matrix may be used, and an ion selective film may also be used to detect various electrolytes.

Referring to FIG. 2, three indicator electrodes 252 are formed in one detection chamber 220. However, this is just an example, one indicator electrode 252 and one standard electrode 251 may be provided in one detection chamber 220, or more than three indicator electrodes 252 and one standard electrode 251 may be provided in one detection chamber 220 as required.

The detection chamber 220 includes a measurement window 221 through which a probe (refer to 300 in FIG. 4) of the analysis device can access the indicator electrode 252 and the standard electrode 251. In FIG. 3, a sealing member 260 prevents a specimen included in the detection chamber 250 from leaking through the measurement window 221.

The detection chamber 220 may accommodate a standard specimen. The standard specimen provides a standard in analyzing electrolytes. The detection chamber 220 may include an inlet 222 into which the standard specimen is loaded. An air vent 223 facilitates flow of the standard specimen. The detection chamber 220 is connected to a waste chamber 240 via a second channel 241. A second valve 244 formed in the second channel 241 includes an open valve 242 and a closing valve 243. The open valve 242 closes the second channel 241 and opens the second channel 241 when necessary. The closing valve 243 is a valve for closing the second channel 241 when necessary.

The open valve 242 or the closing valve 243 may be embodied as various kinds of microfluidic valves. For example, similar to a capillary valve, the microfluidic valve may use a valve which is passively opened, when a pressure greater than a predetermined pressure is applied to the valve, or a valve which operates actively by receiving power or energy from outside according to an operation signal. The open valve 242 according to the current embodiment is normally closed and thus, closes a channel so that a fluid does not flow before absorbing an electromagnetic energy. The normally closed valve may include a valve material that exists in a channel in a solidified state at normal temperature to close a channel. The valve material is melted at a high temperature and moves to a space in the channel, and is solidified again with the channel opened. An energy radiated from outside may be an electromagnetic wave. An energy source may be a laser light source radiating a laser beam, a light emitting diode (LED) radiating visible rays or infrared rays, or a Xenon lamp. When the energy source is the laser light source, the energy source may include at least one laser diode. The valve material may use a thermoplastic resin, a phase transition material that is solid at normal temperatures, etc. The phase transition material may be wax, gel, or a thermoplastic resin. A great number of minute exothermic particles absorbing an electromagnetic energy and generating heat may be dispersed in the valve material. When an electromagnetic energy is supplied to the minute exothermic particles by laser light, the temperature of the minute exothermic particles rapidly increases to generate heat, and the minute exothermic particles are uniformly dispersed in the valve material. Therefore, the minute exothermic particles may have a core, including metal components, and a hydrophobe surface structure. The minute exothermic particles may be stored in a carrier oil in a dispersed state. The carrier oil may be a hydrophobe so that the minute exothermic particles having a hydrophobe surface structure are uniformly dispersed.

As illustrated in FIG. 4, the closing valve 243 is formed around the second channel 241 through which a fluid flows so as not to interrupt the flow of the fluid, then receives energy from outside to be melted, and then, when melted, flows into the second channel 241 so as to be solidified, thereby closing the second channel 241.

As illustrated in FIG. 1, the microfluidic device 200 may have a double-plate platform structure in which an upper plate 202 and a lower plate 201 are combined. The lower plate 201 may include an intaglio structure forming chambers, channels, and valves. The upper plate 202 may include the inlet 212, the air vent 213, and the measurement window 221. The upper plate 202 and the lower plate 201 may be combined through various methods, for example, adhesion using adhesives or a double-faced adhesive tape, ultrasonic sealing, laser welding, or the like. The microfluidic device 200 may be formed of a plastic material, which can be easily molded and has a biologically inactive surface, such as acrylic, Polydimethylsiloxane (PDMS), or the like. However, embodiments are not limited thereto, the microfluidic device 200 may be formed of a material having chemical and biological stabilities and a mechanical processability.

In order to perform an electrochemical analysis of a specimen, a standard specimen is loaded into the detection chamber 220 through the inlet 222. A biological material, such as blood, urine, or the like, is loaded into the specimen chamber 211 through the inlet 212. Before the microfluidic device 200 is installed in the rotation driving unit of the analysis device, the inlets 222 and 212 may be closed using wax, or the like. As illustrated in FIG. 4, a probe 300 contacts the indicator electrode 252 and the standard electrode 251 through the measurement window 221. In this case, a potential of the indicator electrode 252 is a standard potential that becomes a standard for electrolyte analysis.

The second channel 241 is closed by the open valve 242. After the potential of the standard specimen is measured, the open valve 242 of the second valve 244 is operated to open the second channel 241. Then, the microfluidic device 200 is rotated to discharge the standard specimen included in the detection chamber 220 to the waste chamber 240 by using a centrifugal force. The closing valve 243 of the second valve 244 is operated to close the second channel 241. Thus, the detection chamber 220 is separated from the waste chamber 240 again.

Measurement of the standard potential and discharge of the standard specimen may be performed after the centrifugation of the specimen.

Next, the microfluidic device 200 is rotated to centrifuge the specimen into a supernatant and a sediment by using a centrifugal force. Then, the first valve 218 is operated to open the first channel 214 and rotate the microfluidic device 200. Then, the supernatant is moved to the detection chamber 220 by a centrifugal force. As illustrated in FIG. 4, the probe 300 contacts the indicator electrode 252 and the standard electrode 251 through the measurement window 221 in order to perform electrochemical analysis. The potential of the indicator electrode 252 is based on the concentration or activity of electrolyte ions that are included in the specimen and can be sensed by the ion selective film 253. The concentration of a certain electrolyte ion included in the specimen may be measured from a difference between or ratio of the standard potential and a measurement potential.

As described above, the electrolyte ions included in the specimen may be electrochemically detected using the disc-shaped microfluidic device 200. In particular, a plurality of electrochemical analysis units 210 are formed in the rotatable disc-shaped microfluidic device 200, so that electrochemical detection from many specimens or many electrolytes included in the specimen can be effectively performed. Also, since centrifugation of the specimen can be performed using the rotation of the microfluidic device 200, the centrifugation and detection of the electrolytes can be performed at a time, thereby increasing the analysis efficiency of the electrolytes.

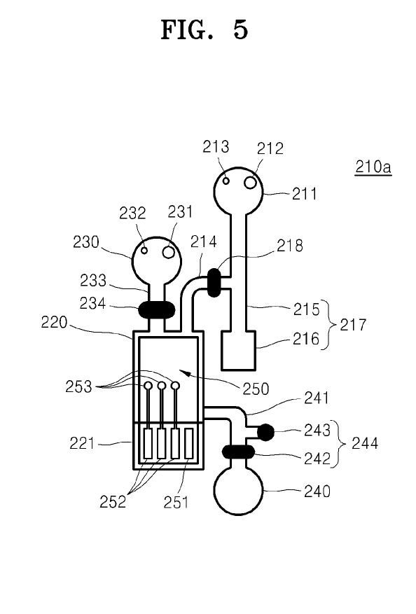

FIG. 5 is a plane view of an electrochemical analysis unit 210 according to another embodiment.

Referring to FIG. 5, an electrochemical analysis unit 210a of the current embodiment and the electrochemical analysis unit 210 illustrated in FIG. 2 are different from each other in that the electrochemical analysis unit 210a includes a standard chamber 230. The standard chamber 230 accommodates a standard specimen. The standard chamber 230 may include an inlet 231 into which the standard specimen is loaded. An air vent 232 facilitates flow of the standard specimen. The standard chamber 230 is connected to the detection chamber 220 through a third channel 233. A third valve 234 formed in the third channel 233 is an open valve which closes the third channel 233 and opens the third channel 233 when necessary.

Electrochemical analysis according to the above description is performed as follows. First, the third valve 234 is operated to open the third channel 233 and supply the standard specimen to a detection chamber 220. A potential of an indicator electrode 252 is measured using a probe 300 to obtain a standard potential. Then, an open valve 242 of a second valve 244 is operated to open the second valve 244 and discharge the standard specimen to a waste chamber 240. A closing valve 243 of the second valve 244 is operated to close a second channel 241. Next, a specimen is centrifuged, and a first valve 218 is operated to open the first channel 241 and supply a supernatant to the detection chamber 220. The potential of the indicator electrode 252 is measured using the probe 300 to obtain a measurement potential. A concentration of electrolyte ions may be measured by a difference between or ratio of the standard potential and the measurement potential.

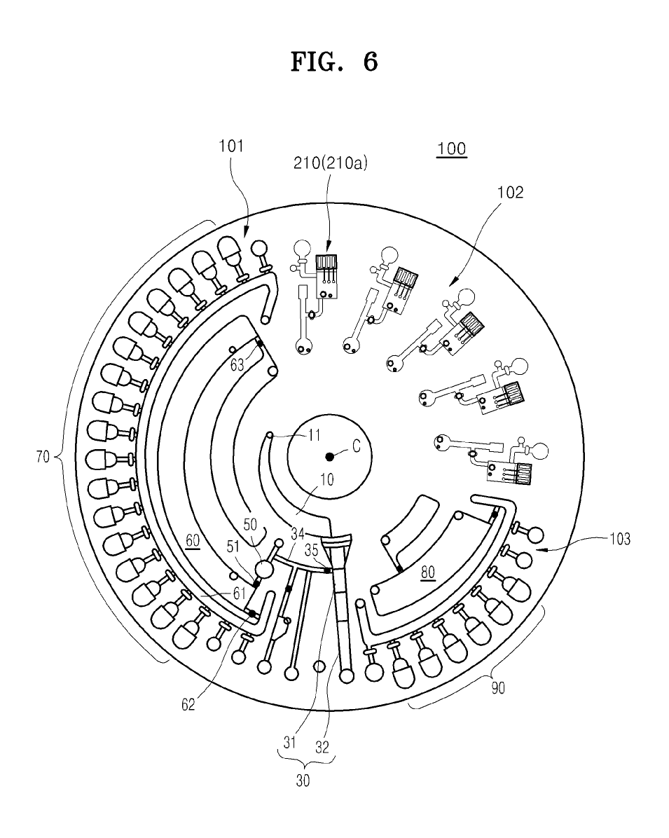

FIG. 6 is a plane view of a microfluidic device 100 according to another embodiment.

Referring to FIG. 6, the microfluidic device 100 according to the current embodiment includes a biochemical analysis unit 101 using a reagent, and at least one electrochemical analysis unit 210 or 210a. A plurality of electrochemical analysis units 210 or 210a may be formed on a region 102 of the microfluidic device 100. Although not shown in the drawing, a specimen chamber 10 of a biochemical analysis unit 101 may be used as the specimen chamber 211 of the electrochemical analysis unit 210 or 210a. That is, the specimen chamber 211 may be connected to the specimen chamber 10 to receive a specimen from the specimen chamber 10. The electrochemical analysis unit 210 or 210a has already been described with reference to FIGS. 1 to 5, and thus, only the biochemical analysis unit 101 will now be described.

A side that is close to an installation unit C in a radial direction will be referred to as an inner part and a side that is far from the installation unit C in a radial direction will be referred to as an outer part. The specimen chamber 10 is disposed in an innermost portion of the microfluidic device 100. A specimen is accommodated in the specimen chamber 10. An inlet 11 into which the specimen is loaded may be formed in the specimen chamber 10.

A specimen sharing unit 30 receives the specimen from the specimen chamber 10. For example, the specimen sharing unit 30 may have a predetermined capacity for measuring a predetermined amount of the specimen which is required for examination. Since a centrifugal force is used to transfer the specimen from the specimen chamber 10 to the specimen sharing unit 30, the specimen sharing unit 30 is located in an outer region of the specimen chamber 10. The specimen sharing unit 30 may act as a centrifugation device for dividing the specimen (for example, blood) into a supernatant and a sediment by using rotation of the microfluidic device 100. For example, the specimen sharing unit 30 may include a channel shaped-sup ematant collection unit 31 which extends outward in a radial direction and a sediment collection unit 32, which is located in the end portion of the supernatant collection unit 31 and has a space capable of collecting a large amount of sediment.

The supernatant (for example, the supernatant may be serum when blood is used as the specimen) collected in one side portion of the supernatant collection unit 31 is supplied to the next member through a specimen supplying channel 34. A valve 35 for controlling flow of the supernatant may be formed in the specimen supplying channel 34. The valve 35 is an open valve as described above.

The specimen supplying channel 34 is connected to a supernatant measuring chamber 50 accommodating the supernatant separated from the specimen. The supernatant measuring chamber 50 is connected to a dilution chamber 60 through a valve 51. The valve 51 is an open valve as described above.

The dilution chamber 60 provides a diluted solution in which the supernatant and the dilution buffer is mixed according to a predetermined ratio. The dilution chamber 60 accommodates a predetermined amount of diluted solution in consideration of a dilution ratio of the supernatant to the dilution buffer. The supernatant measuring chamber 50 may be designed so as to have a capacity capable of accommodating a predetermined amount of specimen in consideration of the dilution ratio. As long as the valve 51 is maintained closed, the specimen exceeding the capacity of the supernatant measuring chamber 50 cannot enter the supernatant measuring chamber 50. Accordingly, only a predetermined amount of supernatant may be supplied to the dilution chamber 60.

Reagent chambers 70 are disposed in an outer region of the dilution chamber 60. The reagent chambers 70 are connected to the dilution chamber 60 through a distribution channel 61. The distribution of the diluted solution through the distribution channel 61 may be controlled by a valve 62. A valve 63 provides an air vent so that the diluted solution is easily distributed to the reagent chambers 70. The valves 62 and 63 are open valves as described above. The reagent chambers 70 accommodate reagents that react with the diluted solution in different ways respectively. The reagents may be used to analyze Albumin (ALB), Amylase (AMY), Urea Nitrogen (BUN), Total Cholesterol (CHOL), Creatinine (CRE), Glucose (GLU), Gamma Glutamyl Transferase (GGT), High-Density Lipoprotein cholesterol (HDL), Lactate Dehydrogenase (LD), Total Protein (TP), Triglyceride (TRIG), Uric Acid (UA), alanine aminotransferase (ALT), Alkaline Phosphatase (ALP), aspartate aminotransferase (AST), Creatine Kinase (CK), Direct Bilirubin (D-BIL), and Total Bilirubin (T-BIL).

The microfluidic device 100 may include a standard unit 103 which does not receive a specimen from the specimen chamber 10. The dilution chamber 80 may store the dilution buffer in order to obtain a detection standard value. Reaction chambers 90 for obtaining the detection standard value may be formed in an outer region of the dilution chamber 80 that does not receive the specimen. The reaction chambers 90 may be empty or may be filled with distilled water.

The reagent may be a liquid state or a lyophilized solid state. Also, the reagent may be a lyophilized reagent accommodated in a cartridge. In this case, the cartridge accommodating the lyophilized reagent may be accommodated in the reagent chamber 70.

The reagent reacts with the specimen dilution buffer to represent a predetermined color, and may be used to detect the concentration of a target for analyzing by measuring an optical characteristic, for example, absorbance, by the use of an optical detection means.

The disc-shaped rotatable microfluidic device 100 as described above includes a biochemical analysis unit 101 using reagent and electrochemical analysis units 210 and 210a, so that more an effective and stable analysis method selected between a biochemical analysis method and an electrochemical analysis method can be used according to the target for analyzing in order to increase accuracy of the analysis. Also, the biochemical analysis and the electrochemical analysis can be performed in the microfluidic device by performing one process, and thus, the analysis of a specimen can be rapidly performed.

It should be understood that the embodiments described herein should be considered in a descriptive sense only and not for purposes of limitation. Descriptions of features or aspects within each embodiment should typically be considered as available for other similar features or aspects in other embodiments.

What is claimed is:

1. A microfluidic device which has a disc-shape, the microfluidic device comprising:
a specimen chamber which accommodates a specimen;
a detection chamber which receives the specimen from the specimen chamber; and
an ion sensor which is formed in the detection chamber to electrochemically detect electrolytes in the specimen, the ion sensor comprising a standard electrode, an indicator electrode and an ion selective film formed on a portion of the indicator electrode.

2. The microfluidic device of claim 1 comprising:
a centrifugation unit which centrifuges the specimen accommodated in the specimen chamber into a supernatant and a sediment when the microfluidic device is rotated;
a first channel which connects the centrifugation unit to the detection chamber; and
a first valve which is configurable from a closed state, which closes the first channel, to an open state, which opens the first channel.

3. The microfluidic device of claim 1, wherein the detection chamber accommodates a standard specimen, and
wherein the microfluidic device comprises:
a waste chamber which accommodates the standard specimen discharged from the detection chamber,
a second channel which connects the detection chamber and the waste chamber, and
a second valve which regulates flow of a fluid through the second channel.

4. The microfluidic device of claim 3, wherein the second valve comprises:
an open valve which is configurable from a closed state, which closes the second channel, to an open state, which opens the second channel; and
a closing valve which is configurable from an open state, which opens the second channel, to a closed state, which closes the second channel.

5. The microfluidic device of claim 1 comprising:
a standard chamber which accommodates a standard specimen;
a third channel which connects the standard chamber to the detection chamber; and
a third valve which is changeable from a closed state, which closes the third channel is closed, to an open state, which opens the third channel.

6. The microfluidic device of claim 5 comprising:
a waste chamber which receives and accommodates the standard specimen discharged from the detection chamber;
a second channel which connects the detection chamber to the waste chamber; and
a second valve which regulates flow of a fluid through the second channel.

7. The microfluidic device of claim 6, wherein the second valve comprises:
an open valve which is configurable from a closed state, which closes the second channel, to an open state, which opens the second channel; and
a closing valve which is configurable from an open state, which opens the third channel, to a closed state, which closes the second channel.

8. The microfluidic device of claim 1, further comprising a biochemical analysis unit which analyzes components of the specimen by using a reaction between the specimen and a reagent.

9. The microfluidic device of claim 8, wherein the biochemical analysis unit comprises:
a dilution chamber which dilutes the specimen according to a predetermined dilution ratio; and
a reagent chamber which accommodates a reagent and receives the diluted specimen from the dilution chamber.

10. The microfluidic device of claim 9, wherein the biochemical analysis unit comprises a centrifugation unit which centrifuges the specimen into a supernatant and a sediment, the dilution chamber dilutes the centrifuged supernatant, and the diluted supernatant is supplied to the reagent chamber.

11. A microfluidic device which has a disc-shape, the microfluidic device comprising:
a biochemical analysis unit which analyzes components of a specimen using a reaction between the specimen and a reagent; and
an electrochemical analysis unit which electrochemically detects electrolytes in the specimen by using an ion selective film.

12. The microfluidic device of claim 11, wherein the electrochemical analysis unit comprises:
a specimen chamber which accommodates the specimen;
a detection chamber which accommodates a standard specimen;
a first channel which connects the specimen chamber to the detection chamber;
a first valve selectively which is configurable from a closed state, which closes the first channel, to an open state, which opens the first channel;
an ion sensor which is formed in the detection chamber to electrochemically detect the electrolytes in the specimen, the ion sensor comprising a standard electrode, an indicator electrode and an ion selective film formed on a portion of the indicator electrode;
a waste chamber which accommodates the standard specimen discharged from the detection chamber;
a second channel which connects the detection chamber to the waste chamber; and
a second valve which regulates flow of a fluid through the second channel.

13. The microfluidic device of claim 12, wherein the electrical analysis unit further comprises a centrifugation unit which centrifuges the specimen accommodated in the specimen chamber when the microfluidic device is rotated, and the first channel connects the centrifugation unit to the detection chamber.

14. The microfluidic device of claim 11, wherein the electrochemical analysis unit comprises:
a specimen chamber which accommodates a specimen;
a detection chamber;
a first channel which connects the specimen chamber to the detection chamber;
a first valve which is configurable from a closed state, which closes the first channel, to an open state, which opens the first channel;
an ion sensor which is formed in the detection chamber to electrochemically detect the electrolytes in the specimen, the ion sensor comprising a standard electrode, an indicator electrode and an ion selective film formed on a portion of the indicator electrode;
a standard chamber which accommodates a standard specimen;
a third channel which connects the standard chamber to the detection chamber;
a third valve selectively which is configurable from a closed state, which closes the third channel, to an open state, which opens the third channel;
a waste chamber which accommodates the standard specimen discharged from the detection chamber;
a second channel which connects the detection chamber to the waste chamber; and
a second valve which regulates flow of a fluid through the second channel.

15. The microfluidic device of claim 14, wherein the electrical analysis unit further comprises a centrifugation unit which centrifuges the specimen accommodated in the specimen chamber into a supernatant and a sediment when the microfluidic device is rotated.

16. A microfluidic device comprising a a first plate;
a second plate disposed on the first plate, wherein the first and second plates have a disc-shape; and
at least one electrochemical analysis unit formed in the first and second plate, the electrochemical analysis unit comprising:
a detection chamber which receives a specimen; and
an ion sensor which is disposed in the detection chamber and electrochemically detects electrolytes in the specimen,
the ion sensor comprising:
an ion anti-inductive electrode having a potential that is not changed by ions included in the specimen;
an ion selective electrode having a potential that is based on a concentration or activity of electrolyte ions included in the specimen; and
an ion selective film formed on a portion of the ion selective electrode.

17. The microfluidic device of claim 16, wherein the ion selective film includes an ionophore providing selectivity to a certain ion.

18. The microfluidic device of claim 17, wherein the detection chamber includes an opening through which the ion anti-inductive electrode and the ion selective electrode are exposed to an exterior, and a concentration of an electrolyte ion included in the specimen is measured based on a difference or ratio of the potential of the ion anti-inductive electrode and the potential of the ion selective electrode.

19. The microfluidic device of claim 18 further comprising a centrifugation chamber which is connected to the detection chamber by a channel and centrifuges the specimen into a supernatant and a sediment when the microfluidic device is rotated, wherein the supernatant is supplied to the detection chamber for electrochemical analysis.
